(19) United States
(12) Patent Application Publication
(10) Pub. No.: US 2026/0129501 A1
(43) Pub. Date: May 7, 2026

(54) MITIGATING HIGH LATENCY IN LATENCY-SENSITIVE APPLICATIONS

(71) Applicant: T-MOBILE INNOVATIONS LLC, Overland Park, KS (US)

(72) Inventor: Zheng CAI, Fairfax, VA (US)

(21) Appl. No.: 18/938,573

(22) Filed: Nov. 6, 2024

(51) Int. Cl. H04W 28/02; H04L 47/2416; H04W 24/08

(52) U.S. Cl. CPC H04W 28/0236; H04L 47/2416; H04W 24/08

(57) ABSTRACT

Systems and methods are provided for mitigating high latency in latency-sensitive applications within an enhanced Mobile Broadband (eMBB) environment by identifying an application with latency requirements below a specific threshold. Latency is measured across one or more frequency channels within a frequency band, or across one or more physical resource blocks (PRBs). Radio frequency (RF) conditions related to the user device are monitored. Based on this latency data and the observed RF conditions, an optimal frequency channel and/or PRBs are selected and allocated to the latency-sensitive application to ensure it meets the required performance criteria.

### SUMMARY

The present disclosure is directed to mitigating high latency for latency-sensitive applications in a telecommunication network, substantially as shown and/or described in connection with at least one of the Figures, and as set forth more completely in the claims.

According to various aspects of the technology, high latency may be mitigated in latency-sensitive applications by dynamically adjusting the network's modulation and coding scheme (MCS). It involves first identifying a latency-sensitive application and assessing the cell's loading measurement to determine if the cell's utilization is below a predefined threshold. If the load is below the threshold, a prediction may be made as to an optimal reduction in the MCS at the node to enhance reliability and reduce latency. The MCS is then lowered accordingly, improving the application's performance under favorable capacity conditions without compromising other network services.

In other aspects, systems and methods are provided for optimized resource allocation in wireless networks by monitoring both latency across multiple Physical Resource Blocks (PRBs) and the radio frequency (RF) conditions associated with a user device. Based on this real-time data, the system intelligently allocates specific PRBs to a latency-sensitive application running on the user device, ensuring that the chosen PRBs offer optimal performance under the prevailing RF conditions. This approach enhances the application's performance by prioritizing PRBs that minimize latency, improving the overall reliability and efficiency of time-critical services.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a diagram of an exemplary environment in which implementations of the present disclosure may be employed;

FIG. 2 depicts a flow diagram of an exemplary method for managing latency for latency-sensitive applications;

FIG. 3 depicts another flow diagram of an exemplary method for managing latency for latency-sensitive applications;

FIG. 4 depicts another flow diagram of an exemplary method for managing latency for latency-sensitive applications; and

FIG. 5 illustrates an exemplary computing device for use with the present disclosure.

### DETAILED DESCRIPTION

The subject matter of embodiments of the invention is described with specificity herein to meet statutory requirements. However, the description itself is not intended to limit the scope of this patent. Rather, the inventor has contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a geographic service area. A base station suitable for use with the present disclosure may be terrestrial (e.g., a fixed/non-mobile form such as a cell tower or a utility-mounted small cell) or may be extra-terrestrial (e.g., an airborne or satellite form such as an airship or a satellite).

The need for low-latency, high-reliability networks is becoming increasingly needed as applications evolve from traditional mobile broadband usage to more immersive and real-time experiences. While 5G networks were designed to support these use cases through multiple communication modes like eMBB, URLLC, and mMTC (massive Machine Type Communication), the practical implementation of URLLC has been limited. Deploying URLLC at scale requires either a significant sacrifice in network capacity or the installation of densely packed cell sites, which drives up infrastructure costs and limits deployment feasibility.

In current 5G Enhanced Mobile Broadband (eMBB) deployments, latency-sensitive applications are given priority access to resources. However, no intelligent mechanism exists to ensure that these resources are suitable for low-latency transmission. Some PRBs are latency-sensitive, meaning they introduce delays that affect the performance of real-time applications, especially when the user is located at the cell edge. As a result, high-priority applications may still experience unacceptable latency levels, even when allocated more resources.

Further, MCS adjustments offer a potential solution to improve reliability by lowering modulation rates under poor RF conditions. However, current systems are rigid, applying fixed MCS settings across the network without considering real-time conditions like network load, interference levels, and fading patterns. Additionally, without accurate monitoring of cell capacity, valuable unused network resources remain untapped, limiting the ability to trade capacity for lower latency.

Aspects provided herein address these shortcomings by introducing intelligent resource allocation, dynamic MCS adjustments, and the integration of URLLC-like features within eMBB environments. By leveraging AI/ML-driven predictions, the system identifies optimal PRBs and frequency channels with the lowest latency potential. Furthermore, it may dynamically adjust MCS levels based on real-time RF conditions and cell load, improving reliability and ensuring the network can meet the demands of latency-sensitive applications. The invention also ensures network efficiency by predicting and managing capacity usage, activating additional resources only when the network load allows it.

Accordingly, a first aspect of the present disclosure is directed to a method for mitigating high latency for latency-sensitive applications. The method includes identifying a latency-sensitive application in an eMBB environment, wherein the latency-sensitive application has a latency requirement below a threshold. Further, the method includes measuring latency for one or more frequency channels corresponding to a frequency band, monitoring one or more radio frequency conditions corresponding to a user device, and identifying a frequency channel for the latency-sensitive application based on the one or more radio frequency conditions and the measured latency. The method also includes allocating the frequency channel to the latency-sensitive application.

A second aspect of the present disclosure is directed to one or more non-transitory computer readable media that, when executed by one or more computer processing components, cause the one or more computer processing components to perform a method for mitigating high latency for latency-sensitive applications. The method includes monitoring latency for a plurality of PRBs, monitoring one or more radio frequency conditions corresponding to a user device served by a cell, and allocating one or more PRBs of the plurality of PRBs to a latency-sensitive application running on the user device, the allocating based on the one or more radio frequency conditions and the monitored latency.

A third aspect of the present disclosure is directed to a method for mitigating high latency for latency-sensitive applications. The method includes identifying a latency-sensitive application, determining that a cell loading measurement of a cell associated with a user device running the latency-sensitive application is below a threshold, and based on the cell loading measurement being below the threshold, predicting an amount to lower the MCS at the cell. The method also includes lowering the MCS at the cell based on the predicting.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

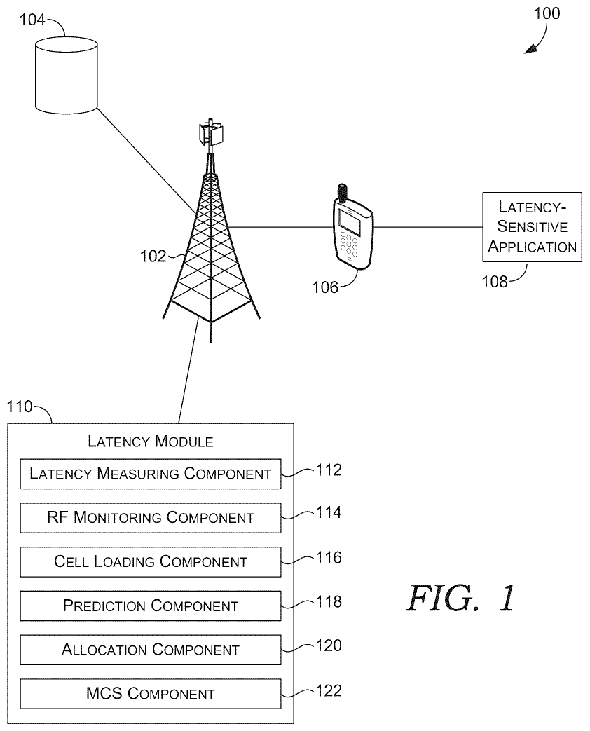

Turning now to FIG. 1, a representative network environment in which the present disclosure may be carried out is illustrated. Such a network environment is illustrated and designated generally as network environment 100. Network environment 100 is but one example of a suitable network environment and is not intended to suggest, including by the form of any illustrated component thereof, any limitation as to the scope of use or functionality of the invention. Neither should the network environment be interpreted as having any dependency or requirement relating to any one or combination of components illustrated. The network environment 100 generally represents a high-level model for wirelessly communicating between a base station and one or more user devices, as discussed in greater detail herein. The network environment 100 comprises a base station 102, a data store 104, a user equipment (UE) 106, a latency-sensitive application 108, and latency module 110.

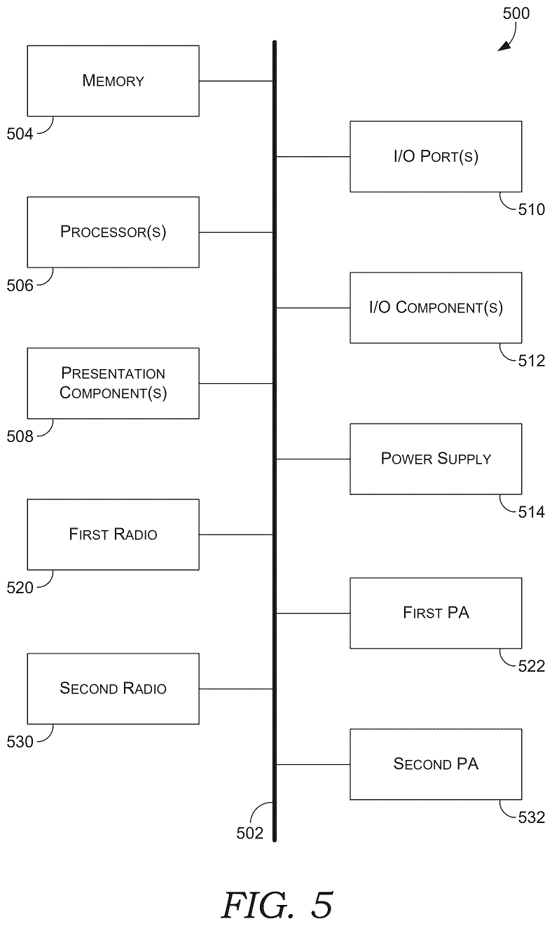

The network environment 100 comprises at least one base station 102 that is configured to wirelessly communicate with one or more user devices, such as the computing device 500 of FIG. 5, which may take the form of UE 106. For the purposes of this disclosure, a base station is used in its general sense, being defined as a station for transmitting and/or receiving RF signals; accordingly, the base station 102 may take the form of a cellular node (e.g. eNodeB, gNodeB, etc.), a relay, an access point (e.g., a Wi-Fi router), or any other desirable emitter and/or receiver of signals that transmits and/or receives wireless signals to/from one or more UEs. A suitable base station is not protocol-specific, it may be configured to be any wireless telecommunication protocol that is compatible with the UE 106, such as 4G, 5G, 6G, 802.11x, or any other wireless standard. A suitable base station is also not exclusive to cellular telecommunication networks, it may take the form of any wireless communication system and used at any desirable frequency (e.g., microwave relays). Base stations consistent with the present disclosure may be configured to provide coverage to certain geographic service area, and will have one or more backhaul connections that connect it to a broader telecommunications and/or information network for the provision of telecommunication and/or information service(s) to the UE 106 and other UEs and devices not shown in FIG. 1. As illustrated, the base station 102 may take the form of a macro cell; however, the base station 102 may take any desirable form, such as a small cell, or a residential Wi-Fi router. As seen in the embodiment illustrated by FIG. 1, base stations suitable for use in the present disclosure may be terrestrial, that is, they are coupled to the earth via a tower or some other structure, such as base station 102; alternatively, a suitable base station may be extra-terrestrial, that is coupled to an aircraft or a satellite.

The network environment 100 comprises a network (not shown). The network comprises any number of components that are generally configured to provide voice and/or data services to wireless communication devices, such as UE 106, which is wirelessly connected to the base station 102. For example, the network may comprise one or more additional wireless base stations, a core network, an IMS network, a PSTN network, or any number of servers, computer processing components, and the like. The network may include access to the World Wide Web, internet, or any number of desirable data sources which may be queried to fulfill requests from wireless communication devices that make requests via the base station 102.

The network environment 100 comprises one or more UEs, with which the base station 102 connects to the network. Generally, UE 106 may have any one or more features or aspects described with respect to the computing device 500 of FIG. 5. In some instances, UE 106 is a device that may run applications with particular latency requirement, such as latency-sensitive application 108. One such application may be an XR application run by an XR device. As used herein, the term “XR device” means any computing device that is executing an XR application. An XR device may be in the form of an XR-specific device (e.g., VR goggles, AR glasses), which is designed and intended for use primarily with XR applications.

For the purposes of the present disclosure, UE 106 utilizes a wireless data connection with the base station 102 to run applications, some of which may be latency-sensitive applications. Accordingly, UE 106 may be said to have a first wireless connection with the base station 102. UE 106 is physically located within the geographic service area served by the base station 102, and may be relatively near the base station 102 or relatively far from the base station 102 (which may also be referred to herein as at or near the cell edge of the geographic service area).

In order to communicate with the UE 106, the base station 102 uses a first wireless connection in the air interface, wherein one or more sets of downlink signals are sent to the UE 106 from the base station 102 and one or more sets of uplink signals are communicated from the UE 106 to the base station 102. Though illustrated as straight lines representing a single, direct, line of sight connection, one skilled in the art will appreciate that the reality of RF communications means that the wireless connection may not be singular (i.e., there may be multiple paths), may not be direct (i.e., there may be reflections and/or refractions that cause the connection(s) to have multiple or indirect paths), and it may not be line of sight (i.e., the connection(s) may be reflected off structures, the ground, or the ionosphere, whether or not a direct line of sight connection exists). Though a single base station is illustrated in FIG. 1, the network environment 100 may comprise multiple base stations, including multiple base stations that serve the same UE, such as through the use of dual connectivity technology; further, additional base stations may provide overlapping or auxiliary coverage in the event an outage occurs at the base station 102. For the purposes of present disclosure, it is sufficient to illustrate that one or more sets of downlink signals originate from, and one or more uplink signals are received at, the base station 102, which utilizes wireless connections to bridge connected UEs to the network.

The network environment 100 comprises one or more computer processing components that form the latency module 110. The latency module 110 may comprise one or more components, taking the form of any combination of hardware components, logical components, and computer-programmed services running on one or more computer processing components that are generally configured to mitigate latency in latency-sensitive applications, such as latency-sensitive application 108. The latency module 110, including its one or more subcomponents, may be disposed at or near the base station 102, within or adjacent to the network, or disposed in multiple locations. As discussed in the present disclosure, the subcomponents of the latency module 110 are divided by function; however, more or fewer components may carry out the functions of the latency module 110, and the functionality described herein with respect to particular subcomponents of the latency module 110 may be performed by other subcomponents of the latency module 110 without departing from the inventive concept conceived herein. Accordingly, the latency module 110 may be said to comprise latency measuring component 112, RF monitoring component 114, cell loading component 116, prediction component 118, allocation component 120, and MCS component 122.

Latency module 110 generally acts as the central controller that coordinates the monitoring, measurement, and mitigation of latency in the network. Upon identifying a latency-sensitive application, such as XR or real-time gaming, the module ensures that the system meets the latency requirements by invoking necessary components. The latency module works continuously to maintain latency below predefined thresholds by collaborating with other components and initiating corrective actions, including modulation adjustments or resource reallocation. Latency measuring component 112 collects and evaluates latency metrics across multiple frequency channels associated with a frequency band. It generates detailed uplink (UL) and downlink (DL) latency reports by monitoring data transmissions in real time. These latency measurements are used for identifying high-latency channels and triggering resource reallocation or MCS adjustments to ensure seamless operation of latency-sensitive applications. The latency data forms a core input to machine learning models, helping predict future network behavior. Latency measurements may be stored on the network, such as in data store 104, for example.

RF monitoring component 114 is responsible for tracking key radio frequency (RF) conditions that influence communication quality. These conditions include Reference Signal Received Power (RSRP), Reference Signal Received Quality (RSRQ), and Signal-to-Interference-plus-Noise Ratio (SINR). This component provides real-time insights into the user device's RF environment, which directly affects signal reliability and latency. By continuously evaluating these conditions, the RF monitoring component 114 enables the system to allocate optimal frequency channels, ensuring improved latency for applications under varying network conditions. RF measurements may be stored on the network, such as in data store 104, for example.

Cell loading component 116 monitors the capacity and current utilization of the cell serving the user device. It determines whether the cell's load is below a predefined threshold, which indicates excess capacity. If the load is below a threshold, the system can initiate measures such as lowering the MCS or increasing packet redundancy to further improve latency. This dynamic monitoring allows the system to optimize performance without compromising the network's overall capacity or the experience of other users.

Prediction component 118 utilizes machine learning (ML) models to forecast network behavior and recommend optimal configurations. It predicts how much to lower the MCS based on historical latency data, RF conditions, and cell load measurements. The predictive models ensure that the system can proactively reallocate resources or adjust MCS levels before latency-sensitive applications experience disruptions. This component improves the efficiency of resource allocation by identifying the best-performing frequency channels and PRBs under current network conditions. The ML models analyze multiple parameters, including latency data, which may include historical and real-time data to identify patterns and make proactive decisions about frequency allocation, modulation adjustments, and resource block selection. Data sources utilized by the ML models may include, for example, RF conditions, such as RSRP, RSRQ, SINR, etc. Other inputs may include real-time latency reports from PRBs and frequency channels and historical latency trends from prior sessions to predict potential issues. An ML model may also consider current utilization of the cell, expressed as a percentage of available capacity for example, and load history patterns, such as peak and off-peak times, to help predict future network congestion. Further, ML models may analyze time of day, weather conditions, and obstacles like buildings or trees that can affect signal propagation, and even location data (e.g., indoor vs. outdoor) that impacts RF conditions. In some aspects, the UE location may also be used by ML models.

Prediction component 118 may use a combination of supervised, unsupervised, and reinforcement learning models to ensure optimal performance. Exemplary models may include a supervised learning model or an unsupervised learning model, among others not specifically mentioned herein. A supervised learning model may comprise a regression model or a classification model. A regression model may be used to predict the impact of changing the MCS on latency. For example, they forecast how much the latency will decrease if the MCS is lowered by a certain degree. A classification model may be used to identify which PRBs or frequency channels are most likely to meet the latency requirement based on real-time conditions. These models use labels derived from historical data to categorize channels as “high-latency” or “low-latency. An unsupervised learning model could include clustering algorithms or anomaly detection. Clustering algorithms may group PRBs and channels based on similar RF conditions and latency behavior. This helps in identifying clusters of channels that are optimal for specific applications. Anomaly detection may detect unusual patterns in latency, RF conditions, or user behavior, triggering the system to adjust resource allocations or reconfigure the network proactively.

ML models may be used for many purposes, as described herein. For example, an ML model may be used for MCS adjustment prediction. When the latency threshold is exceeded, prediction component 118 determines how much to lower the MCS based on real-time and/or historical data. For example, if the SINR is low, the model might recommend switching from 64-QAM to 16-QAM to increase reliability. ML models may also be used for channel and PRB selection. The models may analyze latency reports and RF conditions to identify the best-performing PRBs with low latency and good signal quality. Channels are allocated dynamically based on these predictions, ensuring that time-sensitive applications receive the best available resources. Additionally, ML models may be used for load prediction and resource optimization. Using historical load patterns, the models predict future cell congestion and optimize resource allocation to prevent bottlenecks. For example, if the model predicts that cell load will increase within the next 10 minutes, it can adjust the MCS and allocate PRBs proactively to meet latency requirements. The models may also take into account the user's mobility and environmental factors, predicting when the user might move to a cell edge where signal quality is degraded. The system can prepare by pre-allocating PRBs with more robust signal characteristics or initiating MCS adjustments.

Allocation component 120 may be responsible for dynamically assigning PRBs or frequency channels to UE 106 that is running latency-sensitive application 108. The dynamic assigning may be based on real-time latency measurements, channel availability, and RF conditions. Allocation component 120 prioritizes PRBs with lower latency and better RF conditions, ensuring that applications meet their latency requirements. Allocation decisions are enhanced through machine learning, which allows the system to predict the performance of individual PRBs and select those that will maintain the best user experience.

MCS component 122 is responsible for managing the MCS for the network. When the system detects that the latency of a channel exceeds the threshold, MCS component 122 initiates lower MCS settings to improve transmission reliability and reduce latency. Lowering the MCS increases error correction, ensuring data packets are transmitted reliably, even under poor RF conditions or at the edge of a cell. This component works in tandem with cell loading component 116 to decide whether lowering the MCS is viable without compromising network capacity.

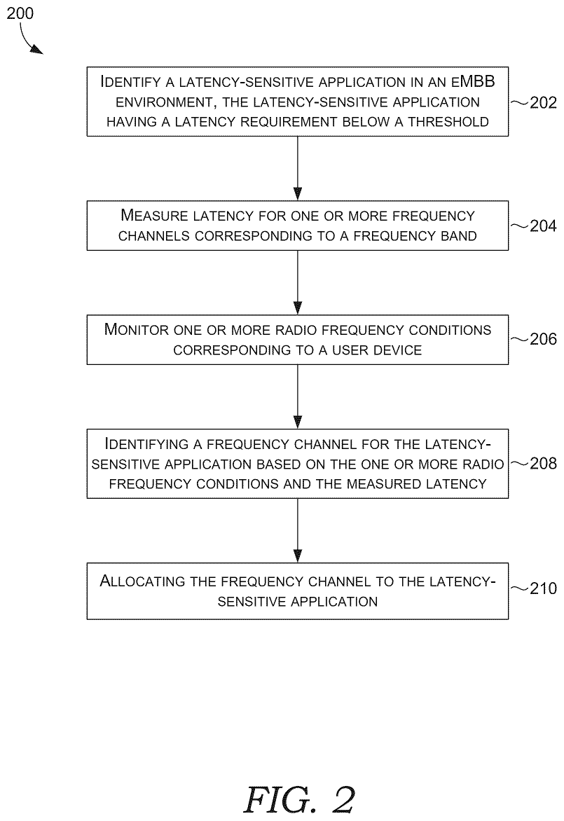

Turning now to FIG. 2, FIG. 2 depicts a flow diagram of an exemplary method 200 for managing latency for latency-sensitive applications. At block 202, a latency-sensitive application is identified in an eMBB environment. In some instances, this application may be an XR or real-time gaming application, but could be any other application that has a latency sensitivity. The application is identified when it is active on a user device. This identification triggers the process to ensure that the application's latency requirements remain below a defined threshold. At block 204, latency is measured for one or more frequency channels corresponding to a particular frequency band. This measurement helps the system determine which channels can best meet the application's low-latency requirements. At block 206, RF conditions corresponding to the user device are monitored. These RF conditions may include RSRP, RSRQ, and SINR. Monitoring these metrics allows the system to account for the user's dynamic environment, such as interference or fading, ensuring that optimal channels are selected. At block 208, a frequency channel is identified for the latency-sensitive application based on the RF conditions and the measured latency. In aspects, this identification is guided by machine learning models to predict performance and ensure the most suitable channels are used.

At block 210, the frequency channel is allocated to the latency-sensitive application. In aspects, one or more ML models may be used, by either a user device or a network component, such as the base station or cell, to predict how much to lower an MCS at the cell. The predicting of how much to lower the MCS at the cell is based on the cell loading measurement of the cell being below the threshold. Further, while FIG. 2 is directed to the allocation of frequency channels, PRBs may also be allocated to the latency-sensitive application based on latency sensitivity, channel availability, and predicted performance of the PRBs. The latency sensitivity, the channel availability, and the predicted performance of the PRBs are determined may be based on one or more machine learning models.

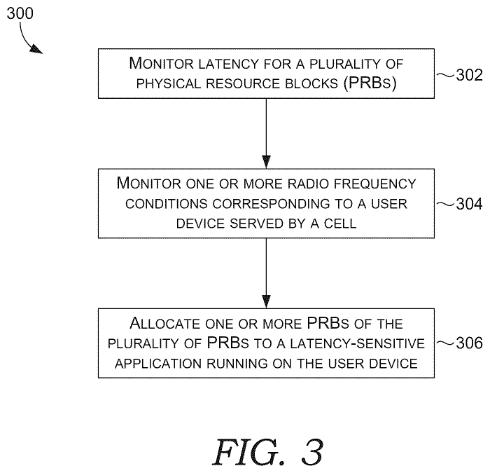

FIG. 3 depicts a flow diagram of an exemplary method 300 for managing latency for latency-sensitive applications. At block 302, latency is monitored for a plurality of PRBs. Monitoring may include receiving latency reports from one or more user devices attached to a cell and generating uplink (UL) and downlink (DL) latency measurements of the cell. At block 304, RF conditions corresponding to a user device served by a cell are monitored. At block 306, one or more PRBs are allocated to a latency-sensitive application running on the user device. The PRBs may be allocated based further on latency sensitivity, channel availability, and predicted performance of the one or more PRBs. Latency sensitivity, channel availability, and predicted performance of the one or more PRBs may be determined based on one or more machine learning models. In some aspects, it may be determined that a cell loading measurement of the cell serving the user device running the latency-sensitive application is below a threshold. In this case, a lower MCS may be initiated at the cell, which may lower the latency to below the threshold.

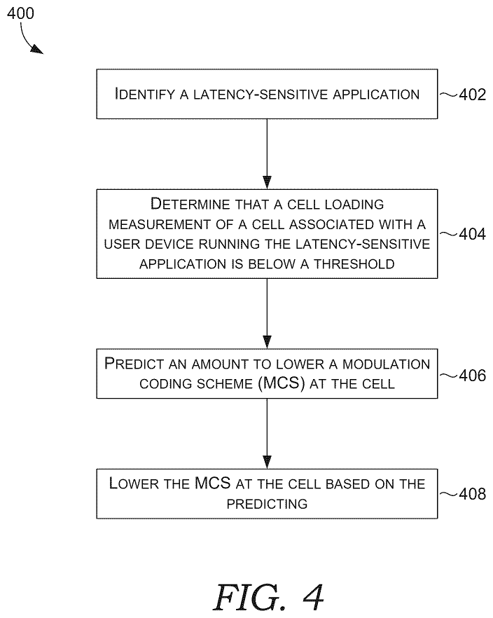

FIG. 4 depicts a flow diagram of an exemplary method 400 for managing latency for latency-sensitive applications. At block 402, a latency-sensitive application is identified. In aspects, this application is currently running or active on a user device served by a cell. The latency-sensitive application may be, for example, an extended reality (XR), holographic communications, or real-time gaming application. At block 404, it is determined that a cell loading measurement of the cell associated with the user device is below a threshold. At block 406, an amount to lower an MCS at the cell is predicted such as, for example, by one or more ML models. At block 408, the MCS at the cell is lowered based on the predicting. In some aspects, PRBs may be dynamically identified and allocated based on latency sensitivity, channel availability, and predicted performance of the PRBs. These parameters may be determined based on one or more machine learning models. Latency of PRBs and/or frequency channels may be measured, and may include receiving latency reports from one or more user devices attached to a cell and generating uplink (UL) and downlink (DL) latency measurements of the cell.

Referring to FIG. 5, a representative computer environment is shown and designated generally as computing device 500 that is suitable for use in implementations of the present disclosure. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. In aspects, the computing device 500 is generally defined by its capability to transmit one or more signals to an access point and receive one or more signals from the access point (or some other access point); the computing device 500 may be referred to herein as a user equipment, wireless communication device, or user device. The computing device 500 may take the form of a wireless access device that acts as a more localized and consolidated access point that provides end user wireless devices access to a broader network; examples of wireless access devices include fixed wireless access (FWA) devices and mobile hotspots. The computing device 500 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) devices (e.g., virtual reality, augmented reality, or mixed reality devices), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 500 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, computing device 500 includes bus 502 that directly or indirectly couples the following devices: memory 504, one or more processors 506, one or more presentation components 508, input/output (I/O) ports 510, I/O components 512, and power supply 514. Bus 502 represents what may be one or more busses (such as an address bus, data bus, or combination thereof). Although the devices of FIG. 5 are shown with lines for the sake of clarity, in reality, delineating various components is not so clear, and metaphorically, the lines would more accurately be grey and fuzzy. For example, one may consider a presentation component such as a display device to be one of I/O components 512. Also, processors, such as one or more processors 506, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 500 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 504 includes computer-storage media in the form of volatile and/or nonvolatile memory. Memory 504 may be removable, non-removable, or a combination thereof. Exemplary memory includes solid-state memory, hard drives, optical-disc drives, etc. Computing device 500 includes one or more processors 506 that read data from various entities such as bus 502, memory 504 or I/O components 512. One or more presentation components 508 presents data indications to a person or other device. Exemplary one or more presentation components 508 include a display device, speaker, printing component, vibrating component, etc. I/O ports 510 allow computing device 500 to be logically coupled to other devices including I/O components 512, some of which may be built in computing device 500. Illustrative I/O components 512 include a microphone, joystick, game pad, satellite dish, scanner, printer, wireless device, etc.

A radio 520 and a second radio 530 represent radios that facilitate communication with one or more wireless networks using one or more wireless links. In aspects, the first radio 520 utilizes a first transmitter 522 to communicate with a wireless network on a first wireless link and the second radio 530 utilizes the second transmitter 532 to communicate on a second wireless link. Though two radios are shown, it is expressly conceived that a computing device with a single radio (i.e., the first radio 520 or the second radio 530) could facilitate communication over one or more wireless links with one or more wireless networks via both the first transmitter 522 and the second transmitter 532. Illustrative wireless telecommunications technologies include CDMA, GPRS, TDMA, GSM, 802.11, and the like. One or both of the first radio 520 and the second radio 530 may carry wireless communication functions or operations using any number of desirable wireless communication protocols, including 802.11 (Wi-Fi), WiMAX, LTE, 3G, 4G, 5G, NR, VoLTE, or other VoIP communications. In aspects, the first radio 520 and the second radio 530 may be configured to communicate using the same protocol but in other aspects they may be configured to communicate using different protocols. In some embodiments, including those that both radios or both wireless links are configured for communicating using the same protocol, the first radio 520 and the second radio 530 may be configured to communicate on distinct frequencies or frequency bands (e.g., as part of a carrier aggregation scheme). As can be appreciated, in various embodiments, each of the first radio 520 and the second radio 530 can be configured to support multiple technologies and/or multiple frequencies; for example, the first radio 520 may be configured to communicate with a base station according to a cellular communication protocol (e.g., 4G, 5G, 6G, or the like), and the second radio 530 may configured to communicate with one or more other computing devices according to a local area communication protocol (e.g., IEEE 802.11 series, Bluetooth, NFC, z-wave, or the like).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for mitigating high latency for latency-sensitive applications, the method comprising:
identifying a latency-sensitive application in an eMBB environment, wherein the latency-sensitive application has a latency requirement below a threshold;
measuring latency for one or more frequency channels corresponding to a frequency band;
monitoring one or more radio frequency conditions corresponding to a user device;
identifying a frequency channel for the latency-sensitive application based on the one or more radio frequency conditions and the measured latency; and
allocating the frequency channel to the latency-sensitive application.

2. The method of claim 1, further comprising determining that a cell loading measurement of a cell associated with a user device running the latency-sensitive application is below a threshold.

3. The method of claim 2, further comprising predicting how much to lower a modulation coding scheme (MCS) at the cell based on one or more machine learning models.

4. The method of claim 3, wherein the predicting how much to lower the MCS at the cell is based on the cell loading measurement of the cell being below the threshold.

5. The method of claim 1, wherein the latency-sensitive application comprises at least one of extended reality (XR), holographic communications, or real-time gaming.

6. The method of claim 1, further comprising dynamically allocating physical resource blocks (PRBs) based on latency sensitivity, channel availability, and predicted performance of the PRBs.

7. The method of claim 6, wherein the latency sensitivity, the channel availability, and the predicted performance of the PRBs are determined based on one or more machine learning models.

8. The method of claim 1, wherein the one or more radio frequency conditions comprise reference signal received power (RSRP), reference signal received quality (RSRQ), or signal-to-interference-plus-noise ratio (SINR).

9. One or more non-transitory computer readable media that, when executed by one or more computer processing components, cause the one or more computer processing components to perform a method for mitigating high latency for latency-sensitive applications, the method comprising:
monitoring latency for a plurality of physical resource blocks (PRBs);
monitoring one or more radio frequency conditions corresponding to a user device served by a cell; and
allocating one or more PRBs of the plurality of PRBs to a latency-sensitive application running on the user device, the allocating based on the one or more radio frequency conditions and the monitored latency.

10. The one or more non-transitory computer readable media of claim 9, wherein the monitoring the latency further comprises receiving latency reports from one or more user devices attached to a cell and generating uplink (UL) and downlink (DL) latency measurements of the cell.

11. The one or more non-transitory computer readable media of claim 9, wherein the one or more PRBs are allocated based further on latency sensitivity, channel availability, and predicted performance of the one or more PRBs.

12. The one or more non-transitory computer readable media of claim 11, wherein the latency sensitivity, the channel availability, and the predicted performance of the one or more PRBs are determined based on one or more machine learning models.

13. The one or more non-transitory computer readable media of claim 9, further comprising determining that a cell loading measurement of the cell serving the user device running the latency-sensitive application is below a threshold.

14. The one or more non-transitory computer readable media of claim 13, further comprising initiating a lower modulation coding scheme (MCS) at the cell to lower the latency to below the threshold.

15. The one or more non-transitory computer readable media of claim 9, wherein the one or more radio frequency conditions comprise reference signal received power (RSRP), reference signal received quality (RSRQ), or signal-to-interference-plus-noise ratio (SINR).

16. A method for mitigating high latency for latency-sensitive applications, the method comprising:
identifying a latency-sensitive application;
determining that a cell loading measurement of a cell associated with a user device running the latency-sensitive application is below a threshold;
based on the cell loading measurement being below the threshold, predicting an amount to lower a modulation coding scheme (MCS) at the cell; and
lowering the MCS at the cell based on the predicting.

17. The method of claim 16, wherein the latency-sensitive application comprises at least one of extended reality (XR), holographic communications, or real-time gaming.

18. The method of claim 16, further comprising:
monitoring latency of one or more physical resource blocks (PRBs); and
dynamically allocating the PRBs based on latency sensitivity, channel availability, and predicted performance of the PRBs.

19. The method of claim 18, wherein the latency sensitivity, the channel availability, and the predicted performance of the PRBs are determined based on one or more machine learning models.

20. The method of claim 18, wherein the monitoring the latency further comprises receiving latency reports from one or more user devices attached to a cell and generating uplink (UL) and downlink (DL) latency measurements of the cell.
